(19) United States
(12) Patent Application Publication
(10) Pub. No.: US 2021/0312486 A1
(43) Pub. Date: Oct. 7, 2021

(54) DETERMINING DELIVERY RANGE

(71) Applicant: BEIJING SANKUAI ONLINE TECHNOLOGY CO., LTD, Beijing (CN)

(72) Inventors: Xuetao DING, Beijing (CN); Runfeng ZHANG, Beijing (CN); Dong JIA, Beijing (CN); Renqing HE, Beijing (CN); Zhengang GUO, Beijing (CN); Xiaobo HAO, Beijing (CN)

(21) Appl. No.: 17/055,930

(22) PCT Filed: Dec. 19, 2018
(86) PCT No.: PCT/CN2018/122085

§ 371 Date: Nov. 16, 2020

(30) Foreign Application Priority Data
May 17, 2018 (CN) 201810475812.X

(51) Int. Cl. G06Q 30/02; G06N 20/00; G06N 5/04

(52) U.S. Cl. CPC G06Q 30/0205; G06Q 30/0201; G06Q 10/0838; G06N 5/04; G06N 20/00

(57) ABSTRACT

A method for determining a delivery range, including: obtaining historical behavior data in multiple territorial blocks and historical order data of multiple merchants (101); obtaining a target merchant set in each territorial block according to the historical behavior data in the multiple territorial blocks and the historical order data of the multiple merchants (102); and determining a delivery range for each merchant based on the target merchant set in each territorial block (103).

### CROSS-REFERENCE TO RELATED APPLICATIONS

This patent application is a United States national phase of PCT international application PCT/CN2018/122085, filed on Dec. 19, 2018. The PCT international application claims priority to Chinese Patent Application No. 201810475812.X, filed on May 17, 2018 and entitled “METHOD AND APPARATUS FOR DETERMINING DELIVERY RANGE, ELECTRONIC DEVICE, AND STORAGE MEDIUM.” Both applications are incorporated herein by reference in their entirety.

### TECHNICAL FIELD

Embodiments of the present disclosure relate to a method and an apparatus for determining a delivery range, an electronic device, and a storage medium.

### BACKGROUND

In an instant delivery scenario, each merchant has its own delivery range. The delivery range of the merchant is a geographical area. On an instant delivery application platform, the merchant is only visible to users located within the merchant's delivery range. In other words, an order relationship only occurs between the merchant and users located within the delivery range. Therefore, the delivery range of the merchant may affect the merchant's order intake and delivery efficiency as well as user experience. If the delivery range is set too small, potential user groups will be small, and the merchant's order intake and a gross merchandise volume (GMV) on the platform will be small. If the delivery range is set too wide, although the potential user groups are large and the quantity of generated orders may be increased to some extent, overall delivery efficiency may be reduced, and user experience is thereby affected.

### SUMMARY

Embodiments of the present disclosure provide a method for determining a delivery range, including:

obtaining historical behavior data in multiple territorial blocks and historical order data of multiple merchants;

determining a target merchant set in each territorial block according to the historical behavior data in the multiple territorial blocks and the historical order data of the multiple merchants; and determining a delivery range for each merchant based on the target merchant set in each territorial block.

The embodiments of the present disclosure provide a computer device. The computer device includes a processor and a memory, the memory stores an executable instruction, and the executable instruction is loaded by the processor and causes the processor to perform the method for determining a delivery range.

The embodiments of the present disclosure provide a computer-readable storage medium. The storage medium stores an executable instruction, and the executable instruction is loaded by a processor and causes the processor to perform the method for determining a delivery range.

### BRIEF DESCRIPTION OF THE DRAWINGS

To describe the technical solutions in the embodiments of the present disclosure more clearly, the following briefly describes the accompanying drawings required for describing the embodiments. Apparently, the accompanying drawings in the following description show merely some embodiments of the present disclosure, and a person of ordinary skill in the art may still derive other drawings from these accompanying drawings without creative efforts.

FIG. 1 is a flowchart of a method for determining a delivery range according to an embodiment of the present disclosure;

FIG. 2 is a flowchart of a method for determining a delivery range according to another embodiment of the present disclosure;

FIG. 3 is a schematic diagram of a prediction process according to an embodiment of the present disclosure;

FIG. 4 is a schematic diagram of a process of determining a delivery range according to still another embodiment of the present disclosure;

FIG. 5 is a schematic diagram of optimizing a delivery range according to an embodiment of the present disclosure;

FIG. 6 is a schematic structural diagram of an apparatus for determining a delivery range according to an embodiment of the present disclosure; and

FIG. 7 is a schematic structural diagram of a computer device according to an embodiment of the present disclosure.

### DETAILED DESCRIPTION

To make principles, technical solutions, and advantages of the present disclosure clearer, the following further describes in detail implementations of the present disclosure with reference to the accompanying drawings.

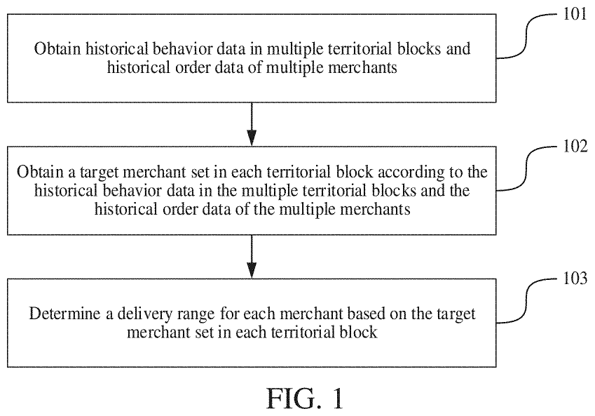

At least one embodiment of the present disclosure provides a method for determining a delivery range, and the method is applicable to a server on an instant delivery application platform. FIG. 1 is a flowchart of a method for determining a delivery range according to an embodiment of the present disclosure. Referring to FIG. 1, the method includes the following steps:

Step 101: Obtain historical behavior data in multiple territorial blocks and historical order data of multiple merchants.

Step 102: Determine a target merchant set in each territorial block according to the historical behavior data in the multiple territorial blocks and the historical order data of the multiple merchants.

Step 103: Determine a delivery range for each merchant based on the target merchant set in each territorial block.

In some embodiments of the present disclosure, the determining a target merchant set in each territorial block according to the historical behavior data in the multiple territorial blocks and the historical order data of the multiple merchants includes:

predicting a conversion rate or an order intake of each merchant in each territorial block according to the historical behavior data in the multiple territorial blocks and the historical order data of the multiple merchants; and

obtaining a target merchant set in each territorial block according to the conversion rate or the order intake of each merchant in each territorial block, the historical order data of the multiple merchants, and the historical behavior data in the multiple territorial blocks.

In some embodiments of the present disclosure, the predicting a conversion rate or an order intake of each merchant in each territorial block according to the historical behavior data in the multiple territorial blocks and the historical order data of the multiple merchants includes:

invoking a prediction model; and

inputting the historical order data of the multiple merchants and the historical behavior data in the multiple territorial blocks into the prediction model, and outputting the conversion rate or the order intake of each merchant in each territorial block.

In some embodiments of the present disclosure, a process of training the prediction model includes:

performing feature extraction on the historical order data of the multiple merchants and the historical behavior data in the multiple territorial blocks to obtain multiple sets of first features, second features, and third features;

performing training based on multiple sets of first features, second features, and third features to obtain the prediction model, where

the first features include at least either a quantity of impressions or a quantity of clicks in a merchant dimension, and a conversion rate or an order intake in the merchant dimension; the second features include at least either a quantity of impressions or a quantity of clicks in a territorial block dimension, and a conversion rate or an order intake in the territorial block dimension; and the third features include at least either a quantity of impressions or a quantity of clicks in a cross dimension of a merchant and a territorial block, and a conversion rate or an order intake in the cross dimension of a merchant and a territorial block.

In some embodiments of the present disclosure, the determining a target merchant set in each territorial block according to the conversion rate or the order intake of each merchant in each territorial block, the historical order data of the multiple merchants, and the historical behavior data in the multiple territorial blocks includes:

combining and optimizing the multiple merchants according to the conversion rate of each merchant in each territorial block, the quantity of impressions in each territorial block, and an average transaction value of each merchant to obtain the target merchant set in each territorial block.

In some embodiments of the present disclosure, the determining a target merchant set in each territorial block according to the conversion rate or the order intake of each merchant in each territorial block, the historical order data of the multiple merchants, and the historical behavior data in the multiple territorial blocks includes:

combining and optimizing the multiple merchants according to the order intake of each merchant in each territorial block and an average transaction value of each merchant to obtain the target merchant set in each territorial block.

In some embodiments of the present disclosure, the combining and optimizing the multiple merchants according to the conversion rate of each merchant in each territorial block, the quantity of impressions in each territorial block, and an average transaction value of each merchant to obtain the target merchant set in each territorial block includes:

applying a first target optimization function to combine and optimize the multiple merchants to obtain the target merchant set in each territorial block, where

the first target optimization function is: max Σ_{g=1}^{M}Σₚ₌₁^{N}pv_{g}×cvr_{p,g}×Priceₚ×C_{p,g} C_{p,g} ∈(0,1).

The combining and optimizing the multiple merchants according to the order intake of each merchant in each territorial block and an average transaction value of each merchant to obtain the target merchant set in each territorial block include:

applying a second target optimization function to combine and optimize the multiple merchants to obtain the target merchant set in each territorial block, where

the second target optimization function is: max Σ_{g=1}^{M}Σₚ₌₁^{N}order_{p,g}×Priceₚ×C_{p,g} C_{p,g} ∈(0,1)

where g is a territorial block index; M is a quantity of the territorial blocks; p is a merchant index; N is a quantity of the merchants; pv_{g} is the quantity of impressions in a territorial block g; cvr_{p,g} is a conversion rate of a merchant p in the territorial block g; order_{p,g} is a predicted order intake of a merchant p in the territorial block g; Priceₚ is an average transaction value of the merchant p; C_{p,g} is a 0-1 identifier indicating whether to allocate a territorial block g to the merchant p as a territorial block in a delivery range of the merchant; C_{p,g} value of 1 means to allocate the territorial block g to the merchant p; and C_{p,g} value of 0 means not to allocate the territorial block g to the merchant p.

In an embodiment, the determining a delivery range for the merchant based on the target merchant set in each territorial block includes:

determining, based on the target merchant set in each territorial block, at least one territorial block corresponding to the merchant;

generating a connected region of each merchant according to the at least one territorial block corresponding to each merchant; and

processing the connected region of each merchant to obtain the delivery range of each merchant.

In some embodiments of the present disclosure, the processing the connected region of the merchant to obtain the delivery range of the merchant includes:

performing combination processing and/or hole-spike processing on the connected region of the merchant according to a three-level road network to obtain the delivery range of the merchant.

In some embodiments of the present disclosure, after determining a delivery range for each merchant based on the target merchant set in each territorial block, the method further includes:

compressing the delivery range of each merchant to obtain compressed region data; and storing the compressed region data.

All the optional technical solutions may be combined in any way to form an alternative embodiment of the present disclosure, of which the details are omitted herein.

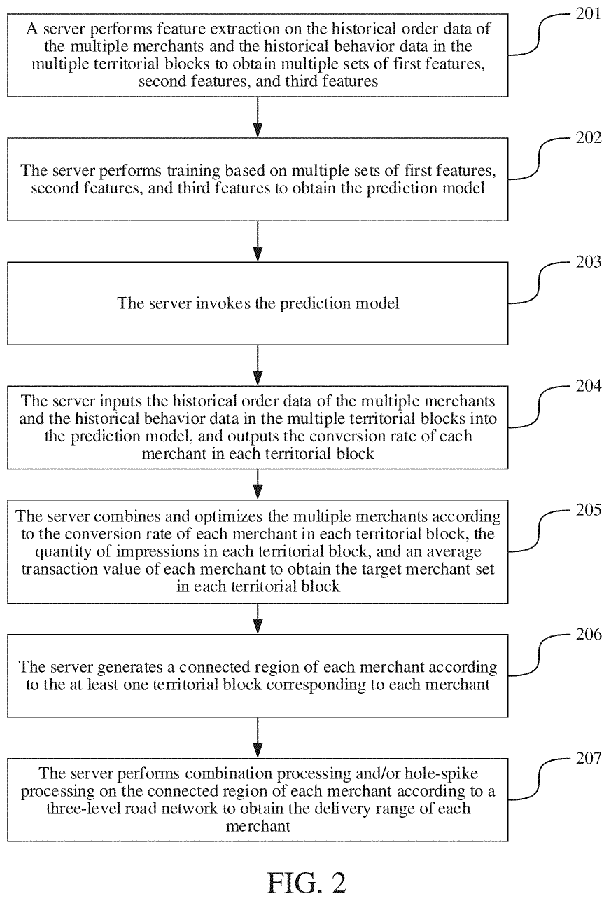

FIG. 2 is a flowchart of a method for determining a delivery range according to an embodiment of the present disclosure. Referring to FIG. 2, the method includes the following steps.

In step 201, a server performs feature extraction on the historical order data of the multiple merchants and the historical behavior data in the multiple territorial blocks to obtain multiple sets of first features, second features, and third features.

The historical order data of the merchant may include information such as an ordering address of an order, a value of an order, and an order delivery duration. The server may perform statistics of the historical order data of the merchant to obtain an average transaction value of the merchant, an average delivery duration for the merchant to finish delivery to a territorial block, and the order intake. The historical behavior data in multiple territorial blocks may include a quantity of impressions and a quantity of clicks in the territorial block, a quantity of impressions and a quantity of clicks of the merchant, and the like. The server may also perform statistics of the historical behavior data in multiple territorial blocks to obtain the quantity of impressions and the quantity of clicks in different dimensions, for example, the quantity of impressions and the quantity of clicks of the merchant, the quantity of impressions and the quantity of clicks in a territorial block, and the quantity of impressions and the quantity of clicks of a merchant in a territorial block. Based on the data obtained through the statistics, a conversion rate in different dimensions may also be obtained. The conversion rate means a ratio of the order intake to the quantity of impressions or the quantity of clicks. To determine a conversion law from different dimensions, the server may extract multiple sets of first features, second features, and third features based on the data when performing feature extraction.

It should be noted that if the prediction model is configured to predict the conversion rate of the merchant in the territorial block, the first features extracted in the process of feature extraction include at least either a quantity of impressions or a quantity of clicks in the merchant dimension, and a conversion rate in the merchant dimension; the second features include at least either a quantity of impressions or a quantity of clicks in a territorial block dimension, and a conversion rate in the territorial block dimension; and the third features include at least either a quantity of impressions or a quantity of clicks in a cross dimension of a merchant and a territorial block, and a conversion rate in the cross dimension of a merchant and a territorial block.

It should be noted that if the prediction model is configured to predict the order intake, the first features extracted in the process of feature extraction include at least either a quantity of impressions or a quantity of clicks in the merchant dimension, and an order intake in the merchant dimension; the second features include at least either a quantity of impressions or a quantity of clicks in a territorial block dimension, and an order intake in the territorial block dimension; and the third features include at least either a quantity of impressions or a quantity of clicks in a cross dimension of a merchant and a territorial block, and an order intake in the cross dimension of a merchant and a territorial block.

It should be noted that the statistical process and the feature extraction process may be performed with respect to at least either the quantity of impressions or the quantity of clicks, which is not specifically limited in the embodiment of the present disclosure.

In step 202, the server performs training based on multiple sets of first features, second features, and third features to obtain the prediction model.

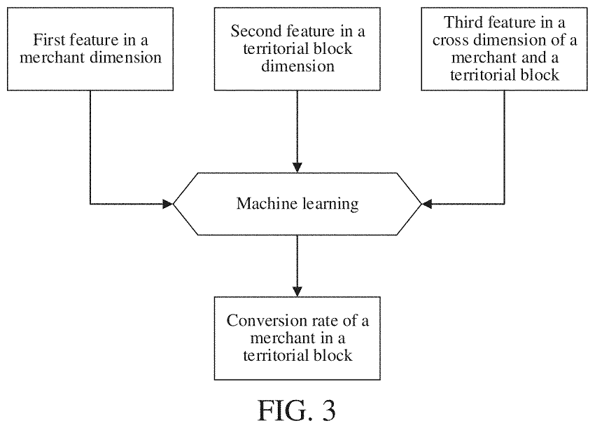

By using the data corresponding to the multiple sets of features as training data, model training may be performed based on any machine learning method to obtain a prediction model. It is assumed that the prediction model is configured to predict the conversion rate of the merchant in any territorial block according to the historical order data of the merchant (the schematic flowchart is shown in FIG. 3). For example, the machine learning method may be a regression algorithm to construct a prediction model that can be configured to represent how the conversion rate is affected by the quantity of impressions and/or the quantity of clicks and the conversion rates in different dimensions.

It should be noted that, for the server, as long as the training is completed before the delivery range is determined, the model training process in steps 201 to 202 may be performed at any time not limited in the embodiment of the present disclosure. In addition, the training process and the subsequent process of determining of the delivery range may be performed by one server, or may be performed by different servers. In the embodiment of the present disclosure, the performing by the same server is used as an example.

In step 203, the server invokes the prediction model.

In determining the delivery range, the server may invoke the prediction model trained based on multiple sets of first features, second features, and third features. In this way, the conversion rate of any merchant in any territorial block can be predicted based on features in a merchant dimension, a territorial block dimension, and a cross dimension of a merchant and a territorial block.

Of course, if the prediction model is configured to predict the order intake, the order intake of any merchant in any territorial block may be predicted by invoking the prediction model.

In step 204, the server inputs the historical order data of the multiple merchants and the historical behavior data in the multiple territorial blocks into the prediction model, and outputs the conversion rate of each merchant in each territorial block.

A previously trained prediction model may provide a law of the conversion rate being affected by various factors. Therefore, based on the law, the conversion rate of the merchant in the territorial block may be predicted for any merchant and any territorial block. Of course, if the prediction model is configured to predict the order intake, the historical order data of the multiple merchants and the historical behavior data in the multiple territorial blocks may be input into the prediction model to predict the order intake of any merchant in any territorial block.

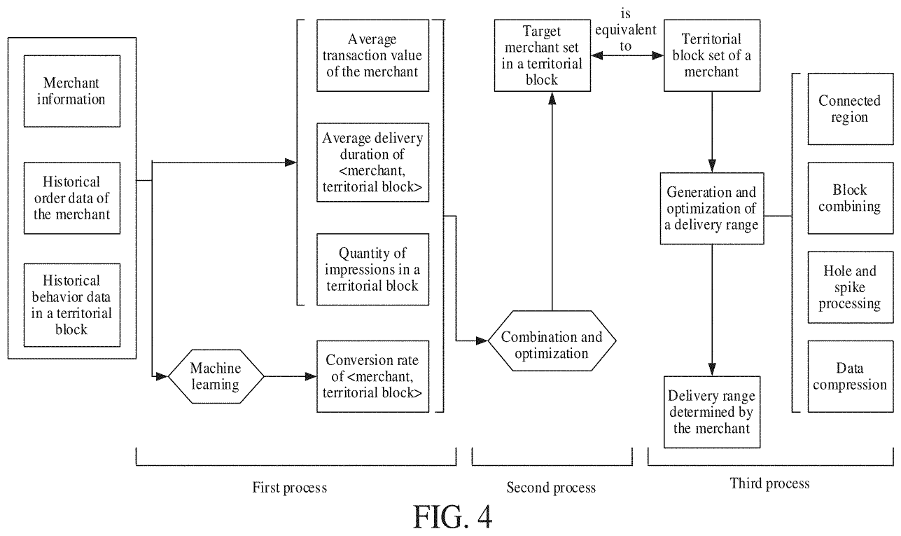

Steps 201 to 204 above actually provide the data required for the combination and optimization process. Referring to the first process in FIG. 4. In the first process, the conversion rate of each merchant in each territorial block is obtained based on the historical order data of multiple merchants and the historical behavior data of the multiple territorial blocks. The conversion rate obtained based on actual data provides real data support during the combination and optimization, and makes a result of the combination and optimization more accurate.

In step 205, the server combines and optimizes the multiple merchants according to the conversion rate of each merchant in each territorial block, the quantity of impressions in each territorial block, and an average transaction value of each merchant to obtain the target merchant set in each territorial block.

After the conversion rate of the merchant in the territorial block is determined, a merchant set that brings a relatively high income in the territorial block may be obtained based on each territorial block. For a purpose of increasing incomes, the following first target optimization function (1) may be designed:

$$max {\sum }_{g = 1}^{M} {\sum }_{p = 1}^{N} {pv}_{p , g} \times {cvr}_{p , g} \times {Price}_{p} \times {C}_{p , g} \qquad ( 1 )$$

where C_{p,g} ∈(0,1); g is a territorial block index; M is a quantity of the territorial blocks; p is a merchant index; N is a quantity of the merchants; pv_{g} is the quantity of impressions in a territorial block g; cvr_{p,g} is a conversion rate of a merchant p in the territorial block g; Priceₚ is an average transaction value of the merchant p; C_{p,g} is a 0-1 identifier indicating whether to allocate a territorial block g to the merchant p as a territorial block in a delivery range of the merchant; C_{p,g} value of 1 means to allocate the territorial block g to the merchant p; and C_{p,g} value of 0 means not to allocate the territorial block g to the merchant p.

If the prediction model is configured to predict the order intake, the following second target optimization function (2) may be applied to combine and optimize the multiple merchants to obtain the target merchant set in each territorial block:

$$max {\sum }_{g = 1}^{M} {\sum }_{p = 1}^{N} {order}_{p , g} \times {Price}_{p} \times {C}_{p , g} \qquad ( 2 )$$

where C_{p,g} ∈(0,1), order_{p,g} is a predicted order intake of the merchant p in the territorial block g, and other parameters have the same meanings as those in the first target optimization function described above.

While the solution uses maximization of the income in the territorial block as an optimization objective, user experience needs to be ensured based on a specific constraint condition. The constraint condition may be that an average delivery duration (or distance) is less than a preset threshold.

The constraint condition may be expressed by Formula (3):

$$\frac{{\sum }_{g = 1}^{M} {\sum }_{p = 1}^{N} {pv}_{g} \times {cvr}_{p , g} \times {Time}_{p , g} \times {C}_{p , g}}{{\sum }_{g = 1}^{M} {\sum }_{p = 1}^{N} {pv}_{g} \times {cvr}_{p , g} \times {C}_{p , g}} \leq T \qquad ( 3 )$$

where Time_{p,g} is an average delivery duration from the merchant p to the territorial block g, and T is a preset limiting threshold of the average delivery duration. That is, a solving result needs to ensure that the average delivery duration is less than the threshold. It should be noted that the constraint condition may also be an average distance. That is, the constraint condition may be expressed using Formula (4):

$$\frac{{\sum }_{g = 1}^{M} {\sum }_{p = 1}^{N} {pv}_{g} \times {cvr}_{p , g} \times Dis tan {ce}_{p , g} \times {C}_{p , g}}{{\sum }_{g = 1}^{M} {\sum }_{p = 1}^{N} {pv}_{g} \times {cvr}_{p , g} \times {C}_{p , g}} \leq Dis tan ce \qquad ( 4 )$$

where Distance_{p,g} is an average delivery distance from the merchant p to the territorial block g, and Distance is a preset limiting threshold of the average delivery distance.

By working out a solution based on the target optimization function and the constraint condition, a target merchant set in each territorial block can be obtained. The merchant's historical order data included in the target merchant set meets the constraint condition and ensures a relatively high income in the territorial block.

It should be noted that the foregoing is only an example of combination and optimization. In a practical scenario, other combination and optimization algorithms and other constraint conditions may be used to generate a territorial block set, which is not specifically limited in the embodiment of the present disclosure.

Step 205 above is a process of recommending an appropriate merchant set for each territorial block by using a combination optimization method (the second process shown in FIG. 4). In this second process, to ensure the user experience and incomes, an average transaction value and an average delivery duration or an average delivery distance or the like are used as a reference, and actual status of impressions is also used to improve accuracy of combination and optimization.

In step 206, the server generates a connected region of each merchant according to the at least one territorial block corresponding to each merchant.

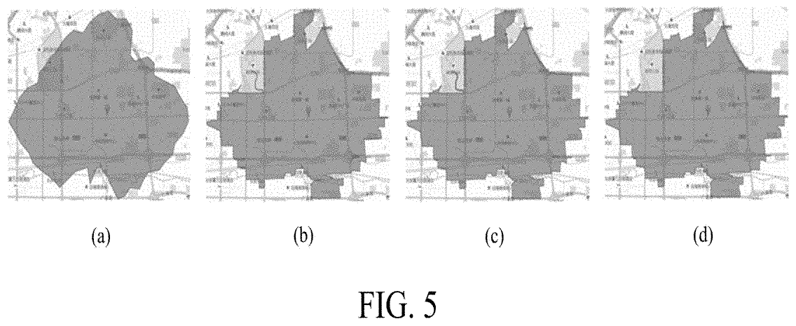

In the above solving process, the target merchant set in each territorial block is obtained, and in fact, at least one territorial block corresponding to each merchant is obtained. Therefore, a delivery range may be further determined pertinently based on the merchant from a perspective of the merchant. For each merchant, at least one territorial block corresponding to the merchant is displayed as independent blocks on a map. Based on the blocks, a polygonal connected region of the merchant may be generated, for example, a polygonal parcel shown in FIG. 5(a).

In step 207, the server performs combination processing and/or hole-spike processing on the connected region of each merchant according to a three-level road network to obtain the delivery range of each merchant.

Based on the connected region, the connected region of each merchant may be subjected to combination processing with reference to geographic information of a residential area and/or an office area in the three-level road network. For example, when a boundary of a connected region is located in any residential area and/or office area, the residential area and/or office area is deleted from the connected region based on the geographic information of the residential area and/or office area, as shown in section (b) of FIG. 5.

Of course, the processed connected region may have holes and spikes. The holes may mean some territorial blocks that are in the connected region but not covered by the connected region. The spikes may mean irregular edges. To make the delivery range more reasonable, the holes may be filled (as shown in section (c) of FIG. 5), and the spikes may be deleted, as shown in section (d) of FIG. 5. A region finally obtained through processing is used as the merchant's delivery range.

It should be noted that, while the server processes the connected region of each merchant to obtain the delivery range of each merchant, the processing may vary depending on a status of the connected region, without necessity of performing the combination processing, hole processing, and spike processing on the connected region of each merchant, so as to avoid waste of computing resources on the server.

Steps 206 to 207 are a process of generating and optimizing the delivery range of the merchant (the third process shown in FIG. 4). In this third process, the delivery range formed by all territorial blocks of the merchant needs to be optimized on the whole from the perspective of the merchant. The optimization may include processes such as the composition, the hole processing, the spike processing, and the like that are mentioned above. Further, in saving the delivery range of each merchant, delivery ranges of the multiple merchants may be compressed, and the compressed region data may be stored. In sending the delivery range of each merchant to a terminal of the merchant, the compressed region data may also be sent to reduce the size of data stored on the terminal.

The territorial block involved in the above implementation process may be a territorial block based on a geohash granularity, or a territorial block based on any territorial division manner granularity. For example, a map may be divided into multiple hexagonal blocks or blocks of other shapes, or the like, which is not limited in the embodiment of the present disclosure.

The method according to the embodiments of the present disclosure makes full use of the historical behavior data in the territorial block and the historical order data of the merchant, and a merchant set that brings a relatively high overall income in the territorial block is found for the territorial block in an automated manner from a perspective of the territorial block, thereby not only ensuring the overall income in the territorial block, but also improving efficiency of delivery and improving accuracy and efficiency of allocation. Further, in obtaining a merchant set for a territorial block, both the conversion of orders and the delivery are considered, thereby improving accuracy of allocation and ensuring user experience. Further, in processing a delivery region, actual distribution of the road network is also considered to further rationalize the delivery region and improve the accuracy of allocation.

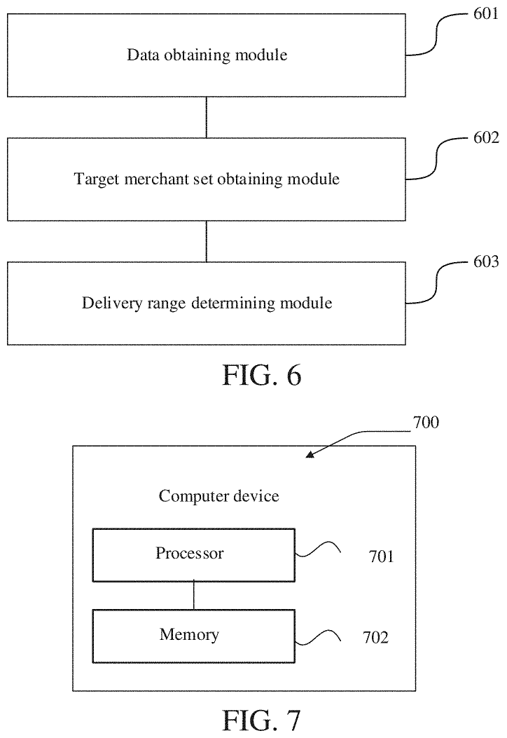

FIG. 6 is a schematic structural diagram of an apparatus for determining a delivery range according to an embodiment of the present disclosure. Referring to FIG. 6, the apparatus includes:

a data obtaining module 601, configured to obtain historical behavior data in multiple territorial blocks and historical order data of multiple merchants;

a target merchant set obtaining module 602, configured to determine a target merchant set in each territorial block according to the historical behavior data in the multiple territorial blocks and the historical order data of the multiple merchants; and

a delivery range determining module 603, configured to determine a delivery range for each merchant based on the target merchant set in each territorial block.

In some embodiments of the present disclosure, the target merchant set obtaining module includes:

a prediction submodule, configured to predict a conversion rate or an order intake of each merchant in each territorial block according to the historical behavior data in the multiple territorial blocks and the historical order data of the multiple merchants; and

an obtaining submodule, configured to obtain a target merchant set in each territorial block according to the conversion rate or the order intake of each merchant in each territorial block, the historical order data of the multiple merchants, and the historical behavior data in the multiple territorial blocks.

In some embodiments of the present disclosure, the prediction submodule is configured to:

invoke a prediction model; and

input the historical order data of the multiple merchants and the historical behavior data in the multiple territorial blocks into the prediction model, and output the conversion rate or the order intake of each merchant in each territorial block.

In some embodiments of the present disclosure, the apparatus further includes a training module. The training module is configured to:

perform feature extraction on the historical order data of the multiple merchants and the historical behavior data in the multiple territorial blocks to obtain multiple sets of first features, second features, and third features; and

perform training based on each set of first features, second features, and third features to obtain the prediction model.

The first features include at least either a quantity of impressions or a quantity of clicks in a merchant dimension, and a conversion rate or an order intake in the merchant dimension. The second features include at least either a quantity of impressions or a quantity of clicks in a territorial block dimension, and a conversion rate or an order intake in the territorial block dimension. The third features include at least either a quantity of impressions or a quantity of clicks in a cross dimension of a merchant and a territorial block, and a conversion rate or an order intake in the cross dimension of a merchant and a territorial block.

In some embodiments of the present disclosure, the target merchant set obtaining module is configured to:

combine and optimize the multiple merchants according to the conversion rate of each merchant in each territorial block, the quantity of impressions in each territorial block, and an average transaction value of each merchant to obtain the target merchant set in each territorial block; or

combine and optimize the multiple merchants according to the order intake of each merchant in each territorial block and an average transaction value of each merchant to obtain the target merchant set in each territorial block.

In some embodiments of the present disclosure, the target merchant set obtaining module is configured to: apply a first target optimization function to combine and optimize the multiple merchants to obtain the target merchant set in each territorial block.

The first target optimization function is: max Σ_{g=1}^{M}Σₚ₌₁^{N}pv_{g}×cvr_{p,g}×Priceₚ×C_{p,g}; or,

the target merchant set obtaining module is configured to: apply a second target optimization function to combine and optimize the multiple merchants to obtain the target merchant set in each territorial block.

The second target optimization function is: max Σ_{g=1}^{M}Σₚ₌₁^{N}order_{p,g}×Priceₚ×C_{p,g}

where g is a territorial block index; M is a quantity of the territorial blocks; p is a merchant index; N is a quantity of the merchants; pv_{g} is the quantity of impressions in a territorial block g; cvr_{p,g} is a conversion rate of a merchant p in the territorial block g; order_{p,g} is a predicted order intake of a merchant p in the territorial block g; Priceₚ is an average transaction value of the merchant p; C_{p,g} is a 0-1 identifier indicating whether to allocate a territorial block g to the merchant p as a territorial block in a delivery range of the merchant; C_{p,g} value of 1 means to allocate the territorial block g to the merchant p; and C_{p,g} value of 0 means not to allocate the territorial block g to the merchant p.

In some embodiments of the present disclosure, the delivery range determining module includes:

a region generating submodule, configured to generate a connected region of each merchant according to the at least one territorial block corresponding to each merchant; and

a processing submodule, configured to process the connected region of each merchant to obtain the delivery range of each merchant.

In some embodiments of the present disclosure, the processing submodule is configured to perform combination processing and/or hole-spike processing on the connected region of each merchant according to a three-level road network to obtain the delivery range of each merchant.

In some embodiments of the present disclosure, the apparatus further includes a compression module, configured to compress delivery ranges of the multiple merchants, and store the compressed region data.

It should be noted that, when the apparatus for determining a delivery range according to the foregoing embodiments determines a delivery range, structural division for the functional modules is described as only an example. In actual application, the foregoing functions may be allocated to and performed by different functional modules as required. That is, an internal structure of a device may be divided into different functional modules to perform all or a part of the functions described above. In addition, the apparatus for determining a delivery range according to the foregoing embodiment is based on the same concept as the method for determining a delivery range described above. For details of a implementation process of the apparatus, refer to the method embodiment, and details are omitted herein.

FIG. 7 is a schematic structural diagram of a computer device according to an embodiment of the present disclosure. The computer device 700 may vary greatly due to different configurations or performance, and may include one or more central processing units (CPU) 701 and one or more memories 702. The memory 702 stores executable instructions, and the executable instructions are loaded by the processor 701 and cause the processor 701 to implement the foregoing methods. Certainly, the server may further include components such as a wired or wireless network interface, a keyboard, and an input/output interface to perform input or output. The server may further include other components for implementing device functions, and details are omitted herein.

In some embodiments of the present disclosure, a computer readable storage medium, for example, a memory including instructions, is further provided. The instructions may be executed by a processor in a terminal, to complete the computer device method in the following embodiment. For example, the computer-readable storage medium may be a non-volatile computer-readable storage medium, a ROM, a random access memory (RAM), a CD-ROM, a magnetic tape, a floppy disk, an optical data storage device, or the like.

A person of ordinary skill in the art may understand that all or some of the steps of the embodiments may be implemented by hardware or a program instructing related hardware. The program may be stored in a computer-readable storage medium. The storage medium may include: a read-only memory, a magnetic disk, or an optical disc.

The foregoing descriptions are merely preferred embodiments of the present disclosure, but are not intended to limit the present disclosure. Any modification, equivalent replacement, or improvement made within the spirit and principle of the present disclosure shall fall within the protection scope of the present disclosure.

1. A method for determining a delivery range, comprising:
obtaining historical behavior data in multiple territorial blocks and historical order data of multiple merchants;
determining a target merchant set in each of the multiple territorial blocks according to the historical behavior data in the multiple territorial blocks and the historical order data of the multiple merchants; and
determining a delivery range for each of the multiple merchants based on the target merchant set in each of the multiple territorial blocks.

2. The method according to claim 1, wherein the determining the target merchant set in each of the multiple territorial blocks according to the historical behavior data in the multiple territorial blocks and the historical order data of the multiple merchants comprises:
predicting at least either a conversion rate or an order intake of each of the multiple merchants in each of the multiple territorial blocks according to the historical behavior data in the multiple territorial blocks and the historical order data of the multiple merchants; and
determining the target merchant set in each of the multiple territorial blocks according to at least either the conversion rate or the order intake of each of the multiple merchants in each of the multiple territorial blocks, the historical order data of the multiple merchants, and the historical behavior data in the multiple territorial blocks.

3. The method according to claim 2, wherein the predicting at least either the conversion rate or the order intake of each of the multiple merchants in each of the multiple territorial blocks according to the historical behavior data in the multiple territorial blocks and the historical order data of the multiple merchants comprises:
invoking a prediction model; and
inputting the historical order data of the multiple merchants and the historical behavior data in the multiple territorial blocks into the prediction model, and outputting at least either the conversion rate or the order intake of each of the multiple merchants in each of the multiple territorial blocks.

4. The method according to claim 3, wherein a process of training the prediction model comprises:
performing feature extraction on the historical order data of the multiple merchants and the historical behavior data in the multiple territorial blocks to obtain multiple sets of first features, second features, and third features;
performing training based on each set of first features, second features, and third features to obtain the prediction model, wherein
the first features comprise at least either a quantity of impressions or a quantity of clicks in a merchant dimension, and at least either a conversion rate or an order intake in the merchant dimension;
the second features comprise at least either a quantity of impressions or a quantity of clicks in a territorial block dimension, and at least either a conversion rate or an order intake in the territorial block dimension; and
the third features comprise at least either a quantity of impressions or a quantity of clicks in a cross dimension of a merchant and a territorial block, and at least either a conversion rate or an order intake in the cross dimension of a merchant and a territorial block.

5. The method according to claim 2, wherein the determining the target merchant set in each of the multiple territorial blocks according to at least either the conversion rate or the order intake of each of the multiple merchants in each territorial block, the historical order data of the multiple merchants, and the historical behavior data in the multiple territorial blocks comprises:
combining and optimizing the multiple merchants according to the conversion rate of each of the multiple merchants in each of the multiple territorial blocks, a quantity of impressions in each of the multiple territorial blocks, and an average transaction value of each of the multiple merchants to obtain the target merchant set in each of the multiple territorial blocks.

6. The method according to claim 5, wherein the combining and optimizing the multiple merchants according to the conversion rate of each of the multiple merchants in each of the multiple territorial blocks, the quantity of impressions in each of the multiple territorial blocks, and an average transaction value of each of the multiple merchants to obtain the target merchant set in each of the multiple territorial blocks comprises:
applying a first target optimization function to combine and optimize the multiple merchants to obtain the target merchant set in each of the multiple territorial blocks; and
the first target optimization function is expressed by Formula (1):
max Σ_{g=1}^{M}Σₚ₌₁^{N}pv_{g}×cvr_{p,g}×Priceₚ×C_{p,g} (1)
wherein a constraint condition of the first target optimization function is expressed by Formula (2):
$$\frac{{\sum }_{g = 1}^{M} {\sum }_{p = 1}^{N} {pv}_{g} \times {cvr}_{p , g} \times {Time}_{p , g} \times {C}_{p , g}}{{\sum }_{g = 1}^{M} {\sum }_{p = 1}^{N} {pv}_{g} \times {cvr}_{p , g} \times {C}_{p , g}} \leq T \qquad ( 2 )$$
wherein g is a territorial block index;
M is a quantity of the territorial blocks;
p is a merchant index;
N is a quantity of the merchants;
pv_{g} is the quantity of impressions in a territorial block g;
cvr_{p,g} is a conversion rate of a merchant p in the territorial block g;
Priceₚ is an average transaction value of the merchant p;
C_{p,g} is a 0-1 identifier indicating whether to allocate a territorial block g to the merchant p as a territorial block in a delivery range of the merchant;
C_{p,g} value of 1 means to allocate the territorial block g to the merchant p;
C_{p,g} value of 0 means not to allocate the territorial block g to the merchant p;
Time_{p,g} is an average delivery duration of delivery to the territorial block g for the merchant p; and
T is a preset average delivery duration threshold.

7. The method according to claim 2, wherein the determining the target merchant set in each of the multiple territorial blocks according to the conversion rate or the order intake of each of the multiple merchants in each of the multiple territorial blocks, the historical order data of the multiple merchants, and the historical behavior data in the multiple territorial blocks comprises:
combining and optimizing the multiple merchants according to the order intake of each of the multiple merchants in each of the multiple territorial blocks and an average transaction value of each merchant of the multiple merchants to obtain the target merchant set in each of the multiple territorial blocks.

8. The method according to claim 7, wherein the combining and optimizing the multiple merchants according to the order intake of each of the multiple merchants in each of the multiple territorial blocks and the average transaction value of the multiple merchants to obtain the target merchant set in each of the multiple territorial blocks comprises:
applying a second target optimization function to combine and optimize the multiple merchants to obtain the target merchant set in each of the multiple territorial blocks; and
the second target optimization function is expressed by Formula (3):
max Σ_{g=1}^{M}Σₚ₌₁^{N}order_{p,g}×Priceₚ×C_{p,g} (3)
wherein a constraint condition of the second target optimization function is expressed by Formula (4):
$$\frac{{\sum }_{g = 1}^{M} {\sum }_{p = 1}^{N} {pv}_{g} \times {cvr}_{p , g} \times Dis tan {ce}_{p , g} \times {C}_{p , g}}{{\sum }_{g = 1}^{M} {\sum }_{p = 1}^{N} {pv}_{g} \times {cvr}_{p , g} \times {C}_{p , g}} \leq Dis tan ce \qquad ( 4 )$$
wherein g is a territorial block index;
M is a quantity of the territorial blocks;
p is a merchant index;
N is a quantity of the merchants;
order_{p,g} is an order intake of a merchant p in the territorial block g;
Priceₚ is an average transaction value of the merchant p;
C_{p,g} is a 0-1 identifier indicating whether to allocate a territorial block g to the merchant p as a territorial block in a delivery range of the merchant;
C_{p,g} value of 1 means to allocate the territorial block g to the merchant p;
C_{p,g} value of 0 means not to allocate the territorial block g to the merchant p;
Distance_{p,g} is an average delivery distance of delivery to the territorial block g for the merchant p; and
Distance is a preset average delivery distance threshold.

9. The method according to claim 1, wherein the determining the delivery range for the merchant based on the target merchant set in each of the multiple territorial blocks comprises:
determining, based on the target merchant set in each of the multiple territorial blocks, at least one territorial block corresponding to the merchant;
generating a connected region of the merchant according to the at least one territorial block corresponding to the merchant; and
processing the connected region of the merchant to obtain the delivery range of the merchant.

10. The method according to claim 9, wherein the processing the connected region of the merchant to obtain the delivery range of the merchant comprises:
performing at least either combination processing or hole-spike processing on the connected region of the merchant according to a three-level road network to obtain the delivery range of the merchant.

11. The method according to claim 1, further comprising:
compressing the delivery range of each merchant to obtain compressed region data; and
storing the compressed region data.

12. (canceled)

13. A computer device, wherein the computer device comprises a processor and a memory, the memory stores an executable instruction, and the executable instruction is loaded by the processor and causes the processor to:
obtain historical behavior data in multiple territorial blocks and historical order data of multiple merchants;
determine a target merchant set in each of the multiple territorial blocks according to the historical behavior data in the multiple territorial blocks and the historical order data of the multiple merchants; and
determine a delivery range for each of the multiple merchants based on the target merchant set in each of the multiple territorial blocks.

14. A computer-readable storage medium, wherein the storage medium stores an executable instruction, and the instruction is loaded by a processor and causes the processor to:
obtain historical behavior data in multiple territorial blocks and historical order data of multiple merchants;
determine a target merchant set in each of the multiple territorial blocks according to the historical behavior data in the multiple territorial blocks and the historical order data of the multiple merchants; and
determine a delivery range for each of the multiple merchants based on the target merchant set in each of the multiple territorial blocks.

15. The computer device according to claim 13, in response to the processor determining the target merchant set in each of the multiple territorial blocks according to the historical behavior data in the multiple territorial blocks and the historical order data of the multiple merchants, causing the processor to:
predict at least either a conversion rate or an order intake of each of the multiple merchants in each of the multiple territorial blocks according to the historical behavior data in the multiple territorial blocks and the historical order data of the multiple merchants; and
determine the target merchant set in each of the multiple territorial blocks according to at least either the conversion rate or the order intake of each of the multiple merchants in each of the multiple territorial blocks, the historical order data of the multiple merchants, and the historical behavior data in the multiple territorial blocks.

16. The computer device according to claim 15, in response to the processor predicting at least either the conversion rate or the order intake of each of the multiple merchants in each of the multiple territorial blocks according to the historical behavior data in the multiple territorial blocks and the historical order data of the multiple merchants, causing the processor to:
invoke a prediction model; and
input the historical order data of the multiple merchants and the historical behavior data in the multiple territorial blocks into the prediction model, and output at least either the conversion rate or the order intake of each of the multiple merchants in each of the multiple territorial blocks.

17. The computer device according to claim 16, wherein a process of training the prediction model comprises:
performing feature extraction on the historical order data of the multiple merchants and the historical behavior data in the multiple territorial blocks to obtain multiple sets of first features, second features, and third features;
performing training based on each set of first features, second features, and third features to obtain the prediction model, wherein
the first features comprise at least either a quantity of impressions or a quantity of clicks in a merchant dimension, and at least either a conversion rate or an order intake in the merchant dimension;
the second features comprise at least either a quantity of impressions or a quantity of clicks in a territorial block dimension, and at least either a conversion rate or an order intake in the territorial block dimension; and
the third features comprise at least either a quantity of impressions or a quantity of clicks in a cross dimension of a merchant and a territorial block, and at least either a conversion rate or an order intake in the cross dimension of a merchant and a territorial block.

18. The computer device according to claim 15, in response to the processor determining the target merchant set in each of the multiple territorial blocks according to at least either the conversion rate or the order intake of each of the multiple merchants in each territorial block, the historical order data of the multiple merchants, and the historical behavior data in the multiple territorial blocks, causing the processor to:
combine and optimize the multiple merchants according to the conversion rate of each of the multiple merchants in each of the multiple territorial blocks, a quantity of impressions in each of the multiple territorial blocks, and an average transaction value of each of the multiple merchants to obtain the target merchant set in each of the multiple territorial blocks.

19. The computer device according to claim 18, in response to the processor combining and optimizing the multiple merchants according to the conversion rate of each of the multiple merchants in each of the multiple territorial blocks, the quantity of impressions in each of the multiple territorial blocks, and an average transaction value of each of the multiple merchants to obtain the target merchant set in each of the multiple territorial blocks, causing the processor to:
apply a first target optimization function to combine and optimize the multiple merchants to obtain the target merchant set in each of the multiple territorial blocks; and
the first target optimization function is expressed by Formula (1):
max Σ_{g=1}^{M}Σₚ₌₁^{N}pv_{g}×cvr_{p,g}×Priceₚ×C_{p,g} (1)
wherein a constraint condition of the first target optimization function is expressed by Formula (2):
$$\frac{{\sum }_{g = 1}^{M} {\sum }_{p = 1}^{N} {pv}_{g} \times {cvr}_{p , g} \times {Time}_{p , g} \times {C}_{p , g}}{{\sum }_{g = 1}^{M} {\sum }_{p = 1}^{N} {pv}_{g} \times {cvr}_{p , g} \times {C}_{p , g}} \leq T \qquad ( 2 )$$
wherein g is a territorial block index;
M is a quantity of the territorial blocks;
p is a merchant index;
N is a quantity of the merchants;
pv_{g} is the quantity of impressions in a territorial block g;
cvr_{p,g} is a conversion rate of a merchant p in the territorial block g;
Priceₚ is an average transaction value of the merchant p;
C_{p,g} is a 0-1 identifier indicating whether to allocate a territorial block g to the merchant p as a territorial block in a delivery range of the merchant;
C_{p,g} value of 1 means to allocate the territorial block g to the merchant p;
C_{p,g} value of 0 means not to allocate the territorial block g to the merchant p;
Time_{p,g} is an average delivery duration of delivery to the territorial block g for the merchant p; and
T is a preset average delivery duration threshold.

20. The computer device according to claim 15, in response to the processor determining the target merchant set in each of the multiple territorial blocks according to the conversion rate or the order intake of each of the multiple merchants in each of the multiple territorial blocks, the historical order data of the multiple merchants, and the historical behavior data in the multiple territorial blocks, causing the processor to:
combine and optimize the multiple merchants according to the order intake of each of the multiple merchants in each of the multiple territorial blocks and an average transaction value of each of the multiple merchants to obtain the target merchant set in each of the multiple territorial blocks.

21. The computer device according to claim 20, in response to the processor combining and optimizing the multiple merchants according to the order intake of each of the multiple merchants in each of the multiple territorial blocks and the average transaction value of the multiple merchants to obtain the target merchant set in each of the multiple territorial blocks, causing the processor to:
apply a second target optimization function to combine and optimize the multiple merchants to obtain the target merchant set in each of the multiple territorial blocks; and
the second target optimization function is expressed by Formula (3):
$$max {\sum }_{g = 1}^{M} {\sum }_{p = 1}^{N} {order}_{p , g} \times {Price}_{p} \times {C}_{p , g} \qquad ( 3 )$$
wherein a constraint condition of the second target optimization function is expressed by Formula (4):
$$\frac{{\sum }_{g = 1}^{M} {\sum }_{p = 1}^{N} {pv}_{g} \times {cvr}_{p , g} \times Dis tan {ce}_{p , g} \times {C}_{p , g}}{{\sum }_{g = 1}^{M} {\sum }_{p = 1}^{N} {pv}_{g} \times {cvr}_{p , g} \times {C}_{p , g}} \leq Dis tan ce \qquad ( 4 )$$
wherein g is a territorial block index;
M is a quantity of the territorial blocks;
p is a merchant index;
N is a quantity of the merchants;
order_{p,g} is an order intake of a merchant p in the territorial block g;
Priceₚ is an average transaction value of the merchant p;
C_{p,g} is a 0-1 identifier indicating whether to allocate a territorial block g to the merchant p as a territorial block in a delivery range of the merchant;
C_{p,g} value of 1 means to allocate the territorial block g to the merchant p;
C_{p,g} value of 0 means not to allocate the territorial block g to the merchant p;
Distance_{p,g} is an average delivery distance of delivery to the territorial block g for the merchant p; and
Distance is a preset average delivery distance threshold.
